(19) United States
(12) Patent Application Publication
(10) Pub. No.: US 2007/0232448 A1
(43) Pub. Date: Oct. 4, 2007

(54) Method and Device for Controlling Distance

(75) Inventor: Thomas Linden, Simmozheim (DE)

Correspondence Address: William C. Gehris;Davidson Davidson & Kappel, 485 Seventh Avenue, 14th Floor, New York, NY, 10018, US

(73) Assignee: Daimler Chrysler AG, Stuttgart (DE)

(21) Appl. No.: 10/577,092

(22) PCT Filed: Sep. 25, 2004
(86) PCT No.: PCT/EP04/10800

§ 371 Date: Mar. 9, 2007

(30) Foreign Application Priority Data
Oct. 25, 2003 (DE) 103 49 882.6

(51) Int. Cl. B60K 31/00

(52) U.S. Cl. 477/183

(57) ABSTRACT

A method and a device for performing inter-vehicle distance control on a vehicle, an actual value (d_{act}) of a distance variable which describes a distance between the vehicle and a vehicle traveling in front being determined, is provided. A plurality of weighting values (gᵢ) for the distance variable are determined as a function of input variables (xᵢ) which describe the driving situation of the vehicle and/or the ambient situation of the vehicle and/or the driving behavior of the driver. From the weighting values in turn a set point value (dₛₑₜₚ) for the distance variable is determined, a braking device and/or driving device of the vehicle being actuated in such a way that the determined actual value (d_{act}) of the distance variable assumes the determined set point value (dₛₑₜₚ). In order to determine the set point value (dₛₑₜₚ) of the distance variable the weighting values (gᵢ) are multiplied by one another.

The invention relates to a method and a device for performing inter-vehicle distance control on a vehicle, an actual value of a distance variable which describes a distance between the vehicle and a vehicle traveling in front being determined. Furthermore, a plurality of weighting values for the distance variable are determined as a function of input variables which describe the driving situation of the vehicle and/or the ambient situation of the vehicle and/or the driving behavior of the driver. From the weighting values in turn a set point value for the distance variable is determined, braking means and/or driving means of the vehicle being actuated in such a way that the determined actual value of the distance variable assumes the determined set point value of the distance variable.

Such a device for inter-vehicle distance control is based on the publication DE 199 43 611 A1. The device determines a set point distance from a vehicle traveling in front, the driving speed of the vehicle being controlled by interventions into the engine drive and/or the brakes of the vehicle in such a way that the distance between the vehicle and a vehicle traveling in front assumes the determined set point distance. So that a safe, that is to say sufficiently large, distance from the vehicle traveling in front is maintained even under unfavorable weather conditions and light conditions, weighting values are determined as a function of input variables which describe the driving speed, the visibility, the state of the road, the activity of the windshield wipers and the switched state of fog lights and headlights, and the said weighting values assume larger positive values the more unfavorable the weather conditions and light conditions which are described by the input variables are. The weighting values constitute, according to one illustrated exemplary embodiment, dimensionless relative values which are added to form a common factor in accordance with which the set point distance is made larger when there are unfavorable weather conditions and light conditions. It is disadvantageous that owing to the addition of the constantly positive weighting values it is possible to compensate a high weighting value which results, for example, from unfavorable weather conditions, and not as a result of a low weighting value which results, for example, from favorable brightness conditions, with the result that the set point distance and thus the distance from the vehicle traveling in front possibly assumes inappropriately high values.

The object of the present invention is therefore to develop a method and a device of the type mentioned at the beginning in such a way that a set point value which is appropriate for the driving situation of the vehicle and/or the ambient situation of the vehicle and/or the driving behavior of the driver is determined for the distance variable.

This object is achieved according to the features of patent claim 1 and of patent claim 7, respectively.

According to the invention for performing inter-vehicle distance control on a vehicle, an actual value of a distance variable which describes a distance between the vehicle and a vehicle traveling in front is determined. Furthermore, a plurality of weighting values for the distance variable are determined as a function of input variables which describe the driving situation of the vehicle and/or the ambient situation of the vehicle and/or the driving behavior of the driver. In turn a set point value for the distance variable is determined from the weighting values, braking means and/or driving means of the vehicle being actuated in such a way that the determined actual value of the distance variable assumes the determined set point value. In order to determine the set point value of the distance variable, the weighting values are multiplied by one another so that when the value intervals within which the weighting values lie are appropriately predefined, a set point value for the distance variable which is appropriate for the driving situation of the vehicle and/or the ambient situation of the vehicle and/or the driving behavior of the driver can be determined. For the sake of clarity, it will be a precondition that a high weighting value corresponds to a high set point value, and a low weighting value corresponds to a low set point value. As a result, due to the multiplicative combination, a high weighting value (>1) can be compensated by a low weighting value (<1), and vice versa. In this way it is possible to prevent both inappropriately large and inappropriately small set point values of the distance variable.

The input variables which are used to describe the driving situation of the vehicle and/or the ambient situation of the vehicle and/or the driving behavior of the vehicle comprise, in particular, one or more of the following variables:
the windshield wiper activity, the velocity and acceleration of the vehicle, the relative velocity and relative acceleration between the vehicle and vehicle traveling in front,
the profile of the carriageway, the inclination of the carriageway, the condition of the carriageway, applicable speed limits, the weather conditions and light conditions in the surroundings of the vehicle, the external temperature,
the driving ability of the driver, the type of driver and the activation of an accelerator pedal which is provided to permit the driver to influence the driving means.

Advantageous embodiments of the method according to the invention emerge from the subclaims.

Advantageously, in order to determine the set point value of the distance variable precisely, the geometric average of the weighting values is formed. The geometric average can be determined on the basis of an easy-to-calculate series expansion, the precision of the determination being greater the higher the number of series elements which are taken into account is.

In order to prevent the averaged weighting values giving rise to excessively large or excessively small set point values for the distance variable, the multiplied weighting values are restricted to a predefined value range. The value range is defined here by predefining an upper and lower limiting value for the multiplied weighting values, the limiting values being predefined as a function of driving state variables which describe the driving state of the vehicle.

In order to easily determine the set point value of the distance variable it is possible to multiply the multiplied weighting values by a suitable reference value for the distance variable, the reference value also being predefined as a function of the driving state variables which describe the driving state of the vehicle.

The aforementioned driving state variables comprise, for example, a velocity variable which describes the velocity of the vehicle and/or an acceleration variable which describes the acceleration or deceleration of the vehicle and/or a relative velocity variable which describes the relative velocity between the vehicle and vehicle traveling in front and/or a relative acceleration variable which describes the relative acceleration or relative deceleration of the vehicle with respect to the vehicle traveling in front.

The reference value and the limiting values are preferably determined in such a way that the set point value of the distance variable does not exceed or drop below a given maximum value or minimum value. The maximum value is given essentially by the maximum range of sensor means which are provided for determining the actual value of the distance variable, while the minimum value is obtained from a minimum distance from the vehicle traveling in front which must not be undershot for safety reasons and which is both as short as possible and also, in the case of full braking of the vehicle traveling in front, permits the driver to brake the vehicle safely to a stationary state without a collision, deceleration time variables which describe the reaction time of the driver (“shock second”) and/or which describe the delay time of braking means of the vehicle caused by the air play, also being taken into account in addition to the driving state variables. The sensor means are, for example, radar sensors or ultrasonic sound sensors which are used in customary inter-vehicle distance control systems. The range of the sensor means is between 30 and 200 meters depending on the design and the frequency range used.

In order to inform the driver that he is driving too close to the vehicle traveling in front or that there is a risk of a rear-end collision, it is possible to issue a driver warning to the driver of the vehicle in the form of visual and/or audible signals if the determined actual value of the distance variable drops below the set point value of the distance variable, that is to say the minimum value of the distance variable, which is given by the lower limiting value of the multiplied weighting values. The driver then still has sufficient time to take suitable counter measures, for example by activating the braking means of the vehicle.

The method according to the invention and the device according to the invention will be described below in more detail with reference to the appended drawings, in which:

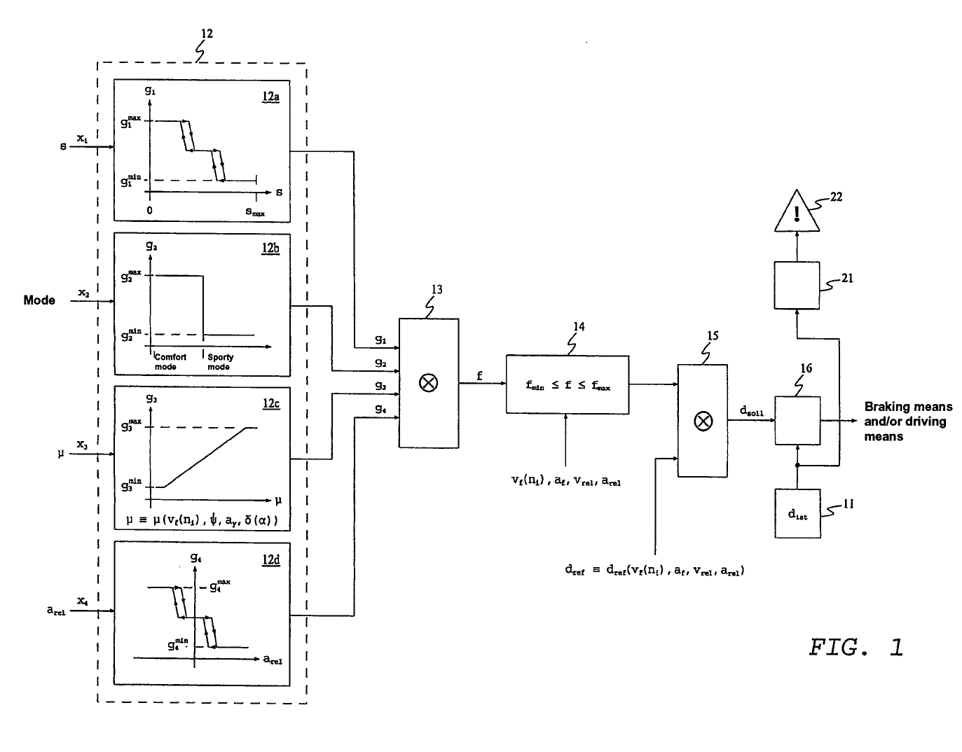

FIG. 1 is the schematic illustration of an exemplary embodiment of the method according to the invention, and

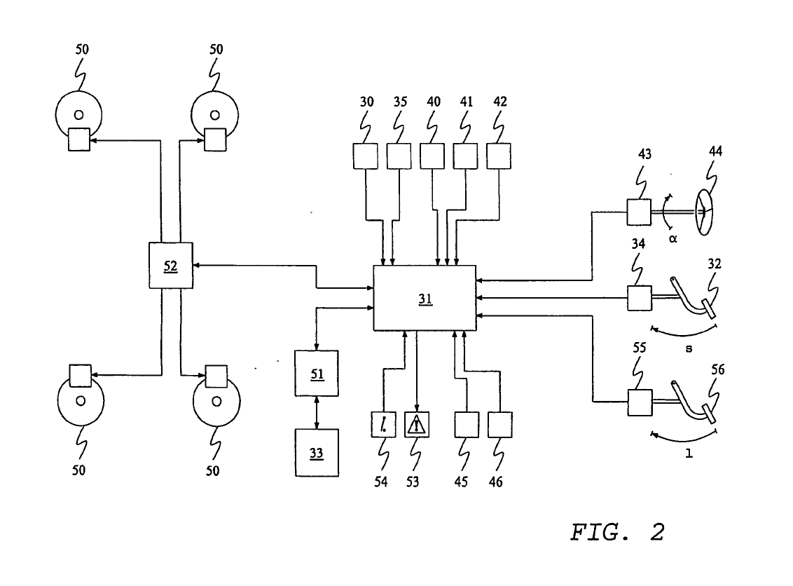

FIG. 2 is a schematically illustrated exemplary embodiment of the device according to the invention.

FIG. 1 illustrates an exemplary embodiment of the method according to the invention for performing inter-vehicle distance control on a vehicle, an actual value d_{act} of a distance variable which describes a distance between the vehicle and a vehicle traveling in front being determined in a first main step 11. At the same time, a plurality of weighting values g_{i,i=1 . . . 4} are determined for the distance variable in substeps 12a to 12d which are part of a second main step 12, as a function of input variables x_{i,i=1 . . . 4} which describe the driving situation of the vehicle and/or the ambient situation of the vehicle and/or the driving behavior of the driver.

For example, a first input variable x₁ is a variable which describes an accelerator pedal deflection s, caused by the driver, of an accelerator pedal (not illustrated) which is provided to permit the driver to influence driving means of the vehicle. If a risk of a rear-end collision with a vehicle traveling in front suddenly occurs, the driver intuitively reacts by reducing the accelerator pedal deflection s with a view to increasing the distance from the vehicle traveling in front to a safe value. Conversely, if the accelerator pedal deflection s is increased the driver intuitively expects the distance from the vehicle traveling in front to be decreased. The first weighting value g₁ is therefore greater the larger the accelerator pedal deflection s caused by the driver is, which comes about in the first substep 12a as a result of the use of a corresponding functional dependence between a first weighting value g₁ and the accelerator pedal deflection s. The functional dependence has in this respect for example the illustrated step-shaped profile, in which case of course any other profile which leads to the desired result is also conceivable instead of a step-shaped profile. In the preferred exemplary embodiment, the steps of the profile according to the first substep 12a each have a hysteresis.

In a second input variable x₂ is a variable which characterizes the driving ability of the driver. The driving ability is specified or predefined, for example, by the driver of the vehicle at an operator control element which is arranged in the vehicle, the driver being able to select between a “comfort mode” and a “sporty mode”. The second weighting value g2 is greater in the “comfort mode” than in the “sporty mode” which is taken into account in the second substep 12b during the determination of the second weighting value g₂ by using a corresponding functional dependence between the second weighting value g₂ and the selected mode. For example, the functional dependence is described by a jump function. Of course, it is also possible to provide more than two selectable modes. Furthermore, it is also possible to conceive of the driving ability being estimated independently of the driver by evaluating suitable variables, for example by evaluating the maximum occurring accelerations or decelerations a_{f} of the vehicle or of the activation speed of operator control elements which are provided for influencing the longitudinal and lateral dynamics of the vehicle.

Furthermore, a third input variable x₃ is a variable which characterizes the state of the road, that is to say the coefficient of friction μ between the surface of the carriageway and the wheels of the vehicle. The third weighting value g₃ has a tendency to increase as the coefficient of friction μ becomes smaller, which is taken into account in the third substep 12c in the form of a corresponding functional dependence between a third weighting value g₃ and a coefficient of friction μ. The coefficient of friction μ is determined, for example, on the basis of a determined velocity variable which describes the velocity v_{f} of the vehicle, and/or a determined yaw rate variable which describes the yaw rate \dot{ψ}, and/or a determined lateral acceleration variable which describes the lateral acceleration ay acting on the vehicle, and/or a steering angle variable which describes the steering angle δ which is set at steerable wheels of the vehicle. Alternatively, the coefficient of friction μ is merely estimated, for which purpose the windshield wiper activity and/or the external temperature are evaluated.

Finally, a fourth input variable x₄ is a variable which describes the acceleration behavior of the vehicle traveling in front in relation to the driver's own vehicle, that is to say, for example, a relative acceleration variable which describes the relative acceleration or relative deceleration aᵣₑₗ of the vehicle in relation to the vehicle traveling in front. The fourth weighting value g₄ becomes larger or smaller here the higher the acceleration or deceleration of the vehicle traveling in front relative to the driver's own vehicle is, which is taken into account in the fourth substep 12d by using a corresponding functional dependence between a fourth weighting value and relative acceleration or relative deceleration aᵣₑₗ. The functional dependence has, for example, the illustrated step-shaped profile, in which case of course any other profile is also possible instead of a step-shaped profile.

In a way which is analogous with the first substep, the steps of the profile which are illustrated in the fourth substep 12d also each have a hysteresis. The hysteresis avoids already small fluctuations in the input variable g₁ or g₄ in the region of one of the jump points of the step-shaped profile leading to continuous changing to and fro between two adjacent step levels of the weighting value x₁ or x₄, which would ultimately result in an extremely unsteady inter-vehicle distance behavior of the vehicle with respect to the vehicle traveling in front owing to the continuously changing set point value of the distance variable.

The weighting values g_{i,i=1 . . . 4} in the present exemplary embodiment constitute dimensionless factors which lie within predefined value intervals, the value intervals each being defined by the predefinition of an upper interval limit g_{i,i=1 . . . 4}^{max} and of a lower interval limit g_{i,i=1 . . . 4}^{min}. In terms of order of magnitude, for example g_{i,i=1 . . . 4}^{max} ≈1.0 . . . 1.5 and g_{i,i=1 . . . 4}^{min}≈0.5 . . . 1.0, the precise value of the interval limits g_{i,i=1 . . . 4}^{max}, g_{i,i=1 . . . 4}^{min} depending on the respective input variable x_{i,i=1 . . . 4}.

The precise functional dependencies between the weighting values g_{i,i=1 . . . 4} and the input variables x_{i,i=1 . . . 4} are determined, like the respectively associated value intervals or interval limits, on the basis of theoretical investigations and/or simulations and/or driving trials.

In a third step 13, the previously determined weighting values g_{i,i=1 . . . 4} are combined multiplicatively to form a combined value f for the distance variable,

$$f ∝ {\prod }_{i = 1 … 4} {g}_{i} ,$$

the multiplicative combination preferably being the geometric average of the weighting values g_{i,i=1 . . . 4},

$$f ∝ \sqrt[4]{{\prod }_{i = 1 … 4} {g}_{i}} .$$

Subsequently, the combined value f is restricted in a fourth main step 14 to a predefined value range. The value range is defined by a predefining an upper limiting value fₘₐₓ and a lower limiting value fₘᵢₙ for the combined value f, the limiting values fₘₐₓ, fₘᵢₙ being predefined as a function of driving state variables which describe the driving state of the vehicle. In terms of order of magnitude, the following applies, by way of example, fₘₐₓ≈1.75 and fₘᵢₙ≈0.25.

In order to determine the set point value dₛₑₜₚ of the distance variable, the combined value f, which is limited if appropriate, is multiplied, in a fifth main step 15, by a suitable reference value d_{ref} of the distance variable, the reference value d_{ref} also being predefined as a function of driving state variables which describe the driving state of the vehicle. In a modification of the illustrated embodiment, it is also possible to limit the set point value dₛₑₜₚ of the distance variable instead of limiting the combined value f.

The driving state variables are, for example, a velocity variable which describes the velocity v_{f} of the vehicle, and/or an acceleration variable which describes the acceleration or deceleration a_{f} of the vehicle, and/or a relative velocity variable which describes the relative velocity vᵣₑₗ between the vehicle and vehicle traveling in front, and/or a relative acceleration variable which describes the relative acceleration or relative deceleration aᵣₑₗ of the vehicle with respect to the vehicle traveling in front.

The reference value d_{ref} and the limiting values fₘₐₓ, fₘᵢₙ are preferably determined in such a way that the set point value dₛₑₜₚ of the distance variable does not exceed or drop below a given maximum or minimum value. The maximum value is given essentially by the maximum range of sensor means which are provided for determining the actual value d_{act} of the distance variable, while the minimum value results from a minimum distance from the vehicle traveling in front which must not be undershot for safety reasons and which is both as short as possible and also, in the case of full braking of the vehicle traveling in front, permits the driver to brake the vehicle safely to a stationary state without a collision, deceleration time variables based on empirical values which describe the reaction time of the driver (“shock second”) and/or which describe the delay time of braking means of the vehicle caused by the air play, also being taken into account in addition to the driving state variables.

Finally, in a sixth main step 16, the braking means and/or the driving means of the vehicle are actuated in such a way that the determined actual value d_{act} of the distance variable assumes the determined set point value dₛₑₜₚ. This is done in the form of the closed-loop or open-loop control operation, the difference, i.e. the deviation between the actual value d_{act} and the set point value dₛₑₜₚ of the distance variable, forming an open-loop or closed-loop control variable for actuating the braking means and/or the driving means.

In order to inform the driver that he is driving too close to the vehicle traveling in front or that there is a risk of a rear-end collision, in a second secondary step 22 a driver warning is issued to the driver of the vehicle in the form of visual and/or audible signals if it is detected in a preceding first secondary step 21 that the determined actual value d_{act} of the distance variable drops below the set point value dₛₑₜₚ of the distance variable, that is to say the minimum value of the distance variable, which is given by the lower limiting value fₘᵢₙ of the combined value f.

FIG. 2 shows an exemplary embodiment of the device according to the invention for performing inter-vehicle distance control on a vehicle. The device comprises of the sensor means 30 which are provided for sensing the distance between the vehicle and a vehicle traveling in front and an evaluation means 31 to which the distance signals of the sensor means 30 are fed. The sensor means 30 are, for example, radar sensors or ultrasonic sound sensors such as are used in customary inter-vehicle distance control systems. At the same time, the evaluation unit 31 determines the weighting values g_{i,i=1 . . . 4} of the distance variable on the basis of the input variables x_{i,i=1 . . . 4}. The functional dependencies which are required to determine the weighting values g_{i,i=1 . . . 4} are stored here in the evaluation unit 31.

The accelerator pedal deflection s which is used to determine the first weighting value gᵢ is in the form of a sensor signal which is provided by an accelerator pedal sensor 34 which interacts with the accelerator pedal 32, and is supplied to the evaluation unit 31.

Furthermore, in order to determine the second weighting value g₂, the evaluation unit 31 senses the switched state of the operator control element 35 which is provided for predefining the driving ability and which permits selection between the “comfort mode” and the “sporty mode”. The operator control element 35 is preferably implemented in an existing combination menu unit and is controlled by a menu.

In order to determine the third weighting value g₃ on the basis of the state of the road, that is to say the coefficient of friction μ, the evaluation unit 31 evaluates the signals of wheel speed sensors 40 which sense the wheel speeds n_{i,i=1 . . . 4} of the wheels of the vehicle, and/or of a yaw rate sensor 41 which senses the yaw rate \dot{ψ} of the vehicle, and/or of a lateral acceleration sensor 42 which senses the lateral acceleration a_{y} acting on the vehicle, and/or a steering wheel angle sensor 43 which senses the steering wheel angle α of a steering wheel 44 which is provided in order to permit the driver to influence the steering angle δ. In particular the velocity variable or the velocity v_{f} of the vehicle which is described by the velocity variable can be derived from the sensed wheel speeds n_{i,i=1 . . . 4}. Both the yaw rate sensor 41 and the lateral acceleration sensor 42 may be part of an electronic stability program (ESP) which is present in the vehicle. Alternatively, the evaluation unit 31 can estimate the coefficient of friction μ by evaluating the signals of a windshield wiper sensor 45 which is provided for sensing the windshield wiper activity, and/or of a temperature sensor 46 which is provided for sensing the external temperature.

Finally, the relative acceleration or relative deceleration aᵣₑₗ which is used to determine the fourth weighting value g₄ is obtained by double derivation over time or corresponding formation of gradients for the distance signals which are made available by the sensor means 30.

The weighting values g_{i,i=1 . . .} which are determined as a function of the input variables x_{i,i=1 . . . 4} are combined by the evaluation unit 31 in a multiplicative fashion to form the combined value f for the distance variable, then limited to the value range defined by the upper and lower limiting values fₘᵢₙ, fₘₐₓ, and finally multiplied by the predefined reference value d_{ref} of the distance variable in order to determine the set point value dₛₑₜₚ for the distance variable.

After the set point value dₛₑₜₚ of the distance variable has been determined, the evaluation unit 31 actuates the braking means 50 which are provided to brake the vehicle and/or the driving means 33 in such a way that the determined actual value d_{act} of the distance variable assumes the determined set point value dₛₑₜₚ. For this purpose, the evaluation unit 31 interacts with a driving means controller 51 in order to actuate the driving means 33, and with a braking means controller 52 in order to actuate the braking means 50, the driving means 33 being, inter alia, an engine, transmission and clutch of the vehicle, and the braking means 50 being, for example, hydraulically or pneumatically activated wheel brake devices.

In order to output the driver warning to the driver, visual and/or audible signal transmitters 53 are provided which are actuated by the evaluation unit 31 if the determined actual value d_{act} of the distance variable drops below the set point value dₛₑₜₚ of the distance variable, that is to say the minimum value of the distance variable, which is given by the lower limiting value fₘᵢₙ of the combined value f.

The device is activated or deactivated, for example, by means of a switch 54 which is connected to the evaluation unit 31 and which can be implemented in an existing combination menu unit and is controlled by a menu. In addition, it is also conceivable to deactivate the device independently of the driver if a driver's request for braking of the vehicle is detected, for which purpose the evaluation unit 31 evaluates the signals of a brake pedal sensor 55 which senses a brake pedal deflection 1, caused by the driver, of a brake pedal 56 which is provided to permit the driver to influence the braking means 50.

The sensors which are necessary to implement the method and the device are generally present in the vehicle so that the inter-vehicle distance control according to the invention can not only be provided cost effectively in new vehicles but also subsequently retrofitted into already existing inter-vehicle distance control systems.

1-7. (canceled)

8. A method for performing inter-vehicle distance control on a vehicle comprising:
determining an actual value of a distance variable describing a distance between the vehicle and a vehicle traveling in front;
determining a plurality of weighting values for the distance variable as a function of input variables describing a driving situation of the vehicle and/or an ambient situation of the vehicle and/or a driving behavior of a driver and determining a set point value for the distance variable as a function of the input variables
actuating a brake and/or driving device of the vehicle so that the determined actual value of the distance variable assumes the determined set point value of the distance variable; and
multiplying the weighting values by one another to determine the set point value of the distance variable.

9. The method as claimed in claim 8 wherein to determine the set point value of the distance variable a geometric average of the weighting values is formed.

10. The method as claimed in claim 8 wherein to determine the set point value of the distance variable the multiplied weighting values are restricted to a predefined value range.

11. The method as claimed in claim 10 wherein the value range is defined by predefining an upper and a lower limiting value for the multiplied weighting values, the limiting values being predefined as a function of driving state variables describing the driving state of the vehicle.

12. The method as claimed in claim 8 wherein the multiplied weighting values for determining the set point value of the distance variable are multiplied by a predefined reference value for the distance variable, the reference value being predefined as a function of driving state variables describing the driving state of the vehicle.

13. The method as claimed in claim 11 further comprising issuing a driver warning to the driver of the vehicle if the determined actual value of the distance variable drops below the set point value of the distance variable given by the lower limiting value of the multiplied weighting values.

14. A device for performing inter-distance control on a vehicle comprising:
an evaluation unit determining an actual value of a distance variable describing a distance between the vehicle and a vehicle traveling in front, the evaluation unit determining a plurality of weighting values for the distance variable as a function of input variables describing a driving situation of the vehicle and/or an ambient situation of the vehicle and/or a driving behavior of a driver, the evaluation unit in turn determining as a function of the weighting values a set point value for the distance variable, the evaluation unit actuating a brake and/or driving device of the vehicle so that the determined actual value of the distance variable assumes the determined set point value of the distance variable, and to determine the set point value of the distance variable the evaluation unit multiplies the weighting values by one another.
